(19) United States
(12) Patent Application Publication
(10) Pub. No.: US 2015/0266262 A1
(43) Pub. Date: Sep. 24, 2015

(54) PERFORATED ADHESIVE ASSEMBLY WITH REMOVABLE NON-PERFORATED BONDING LAYER

(71) Applicant: CONTRA VISION LTD., Bramhall, Stockport, Cheshire (GB)

(72) Inventors: George Roland Hill, Bramhall (GB); Mark David Godden, Cahuzac (FR)

(21) Appl. No.: 14/402,029

(22) PCT Filed: May 24, 2013
(86) PCT No.: PCT/IB2013/001039

§ 371 Date: Nov. 18, 2014

Related U.S. Application Data
(60) Provisional application No. 61/651,929, filed on May 25, 2012.

(51) Int. Cl. B32B 3/26; B32B 37/26; B32B 38/04; B32B 38/10; B32B 37/24; B32B 37/12

(52) U.S. Cl. CPC B32B 3/266; B32B 37/24; B32B 37/12; B32B 38/04; B32B 38/10; B32B 37/26; B32B 2037/243; B32B 2038/047; B32B 2037/268; B32B 2307/40; B32B 2451/00; B32B 2551/00

(57) ABSTRACT

A perforated self-adhesive film assembly capable of being imaged includes a perforated face film; a perforated adhesive layer; a perforated liner, each of the perforated face film, perforated adhesive layer, and perforated liner being perforated with a plurality of holes; and a removable non-perforated bonding layer removably attached to the perforated liner. The removable bonding layer includes a bonding surface. The bonding surface includes one or more of the following: i) a surface topography with a difference between the height of a peak and the depth of a trough within one of said plurality of holes of not less than 5 micron, ii) an adhesion enhancing surface coating, or (iii) a surface spaced from said perforated liner around the complete perimeter of one of said plurality of holes.

### CROSS REFERENCE

This application claims the benefit of priority from U.S. Provisional Patent Application No. 61/651,929, filed, May 25, 2012, titled “PERFORATED ADHESIVE ASSEMBLY WITH REMOVABLE BONDING LAYER,” the entire contents of which are hereby incorporated by reference herein.

### BACKGROUND OF THE INVENTION

1. Field of the Invention

The present invention relates generally to perforated window films, for example self-adhesive perforated window films for imaging to form one way vision or other see-through graphic panels.

2. Description of Related Art

Perforated window films are known in the field of graphics and, more particularly, window graphics. U.S. Pat. No. 4,673,609 reissued as RE 37,186 (Hill) disclosed self-adhesive perforated window films typically comprising a perforated vinyl face film, a perforated adhesive layer and a perforated liner. It was also known in the art to use a perforated self-adhesive assembly with an additional non-perforated backing layer removably adhered to the perforated liner, for the purpose of enabling the assembly to be held down by a vacuum suction bed on a screen printing press and to retain airbrush ink or paint passing through the holes onto the additional non-perforated backing layer, to enable it to be subsequently removed with the unwanted ink. This feature, which became known as an “additional liner” construction was subsequently incorporated into the patent applications which issued as U.S. Pat. No. 5,773,110 and U.S. Pat. No. 5,609,938. Many different types of additional liner construction have been tested and put on sale, including so called self-adhesive, self-wound “application tape” and polypropylene film.

This additional liner construction was largely superseded by the method of U.S. Pat. No. 5,858,155 (Hill et al) “Perforated Adhesive Assembly” with a “replacement liner”, in which a temporary perforated liner is removed and replaced with a non-perforated “replacement liner”. It has better “lay flat” properties. This replacement liner construction allows the pressure-sensitive adhesive to “wet out” against the substantially plane surface of the replacement liner, enabling a more reliable adhesive contact when the liner is removed and the remaining assembly is applied to a glass window or other substrate. This “replacement liner” construction is generally preferred in the art with the exception of when a perforated window film is to be imaged by UV inkjet, as it has been found that UV inkjet deposited on the release surface of the replacement liner can remain in place and “bridge” the holes upon removal of the replacement liner, blocking through vision, one of the essential features of a one way vision or other see-through graphic. This disadvantage of a replacement liner construction especially applies for areas of substantial ink deposit, for example black or other dark areas of a design and, even more so, for an inside application assembly in which a clear, transparent perforated film is imaged with a reverse design (to be right reading when viewed through a window, a clear adhesive layer and the clear film layer), followed by layers of white and black ink to achieve a conventional one-way vision construction. For this reason, it is normal practice to still use the additional liner construction for UV inkjet printing, as the exposed edges of the perforated liner, typically a perforated paper liner with exposed fibers, typically has sufficient bond to the UV ink that passes through the holes and onto the edges of the holes of the perforated liner for the unwanted ink that passes through the holes to be removed with the composite perforated and non-perforated liner. However, it has been found that this method is not totally reliable and, particularly with internal application assemblies comprising multiple layers of UV inkjet ink, “hole bridging” can still occur, cured UV ink spanning across the holes, blocking through vision and looking unsightly.

A problem with solvent inkjet printing a replacement liner construction, typically with a white replacement liner, is that solvent inkjet ink that passes through the holes onto the release surface of the liner, typically silicone, coalesces into small areas of ink leaving relatively large areas of white uncovered replacement liner which has the effect of “whitening” or “washing out” the perceived image. This typically causes a printing machine operator to apply more ink than is necessary in the finished product, which does not have the desired effect, the image remaining “washed out”.

U.S. Pat. No. 7,897,230 (Ross) discloses an additional liner construction with an ink absorbing surface or coating, for the purpose of retaining ink, typically water based or solvent ink in position on the additional liner to give the impression of full ink coverage design. U.S. Patent Application No. 60/941,882 (Hill and Godden) discloses a contrasting colored liner, either a replacement liner or an additional, non-perforated backing liner, typically gray, for example Grayliner™ from Contra Vision North America, Inc., in order to provide a more realistic image that is reasonably representative of a see-through graphic product when applied to a window of a building or vehicle with a relatively dark interior. U.S. Patent Application No. 61/505,829 (Hill and Godden) discloses an open perforated self-adhesive assembly to be typically printed on an inkjet printer with an open gutter, which allows unwanted ink to pass through the holes into the open gutter, the assembly typically having a black surface to the liner to produce a one-way vision product immediately following imaging, a design visible from one side and a black surface visible from the other side enabling relatively good through vision. This construction, for example Contra Vision® Open™ with Blackliner™, overcomes both the UV ink bridging problem and the visual perception problem, as unwanted ink passes through the holes into an open gutter and the remaining product appears as the one-way vision product will in use. However, this open perforated material can only be printed efficiently by inkjet printing machines with an open gutter, other inkjet printing press platens being subject to ink contamination and any suction holes being blocked by ink.

### SUMMARY OF EMBODIMENTS OF THE INVENTION

One or more embodiments of the present invention provides a product and a method of printing with UV inkjet or any other imaging system to overcome one or more of the above-discussed disadvantages of conventional products and methods.

One or more embodiments of the present invention provides a perforated self-adhesive film assembly that is capable of being imaged. The assembly comprises a perforated face film, a perforated adhesive layer and a perforated liner, the assembly perforated with a plurality of holes, the assembly also comprising a removable non-perforated bonding layer removably attached to the perforated liner, the removable bonding layer comprising a bonding surface, the bonding surface comprising one or more of the following:
i) a surface topography surface depth with a difference between the height of a peak and the depth of a trough within one of said plurality of holes of not less than 0.1 micron,
ii) an adhesion enhancing surface coating, or
iii) a surface spaced from said perforated liner around the complete perimeter of one of said plurality of holes.

One or more embodiments of the invention provides a method of making a perforated self-adhesive assembly capable of being imaged, the assembly comprising a perforated face film, a perforated adhesive layer and a perforated liner, the assembly perforated with a plurality of holes, the assembly also comprising a removable non-perforated bonding layer removably attached to the perforated liner, the removable bonding layer comprising a bonding surface, the bonding surface comprising one or more of the following:
(i) a surface topography with a difference between the height of a peak and the depth of a trough within one of said plurality of holes of not less than 5 micron,
(ii) an adhesion enhancing surface coating, or
(iii) a surface spaced from said perforated liner around the complete perimeter of one of said plurality of holes.
   said method comprising:
a) forming a temporary assembly comprising a face film, an adhesive layer and a liner,
b) perforating said temporary assembly with a plurality of holes, and
c) removably adhering said non-perforated bonding layer to the perforated liner side of the perforated assembly.

According to one or more of these embodiments, the method also includes imaging the perforated self-adhesive assembly to form a see-through graphic panel by:
d) imaging said perforated face film with a design layer comprising marking material to form an imaged perforated face film such that additional marking material that passes through said one of said plurality of holes is adhered to said non-perforated removable bonding layer, and
e) removing said non-perforated bonding layer with said additional marking material.

According to one or more of these embodiments, the method also includes forming a see-through graphic panel comprising said imaged perforated face film and said perforated adhesive layer, said perforated adhesive layer adhered to a non-perforated transparent material, said method comprising:
f) removing said perforated liner from said perforated adhesive layer, and
g) adhering said imaged perforated face film and said perforated adhesive layer to said non-perforated transparent material.

The perforated face film typically comprises flexible material, for example a plastic film, for example of pvc, polyester or polyolefin or paper or synthetic paper. To form a one-way vision graphic assembly according to U.S. RE37,186, for application to the outside of a window, the perforated face film typically comprises a laminate of white and black film or white film with a black coating or white film with a black adhesive layer. To form a one-way vision assembly according to U.S. RE37,186 for application to the inside of a window, the perforated face film is typically transparent, to be imaged with the design layer with the design reverse-reading, to be followed by white and black layers, for example by inkjet printing, screen printing or thermal transfer of pigmented resin layers. To form a see-through graphic assembly capable of being backlit according to U.S. Pat. No. 6,212,805, the face film is typically white for outside application and transparent for inside application, the transparent perforated face film being printed with a reverse-reading design backed by a white layer. The design printed reverse-reading is visible right-reading, typically through a window, a transparent perforated adhesive layer and the perforated transparent face film.

The perforated adhesive layer typically comprises pressure-sensitive adhesive, for example a solvent acrylic-based pressure-sensitive adhesive.

The perforated liner typically comprises a paper material, one side having a release surface, typically a silicone coating. Optionally there is a heat-activatable adhesive coating on the other side of the perforated liner to be used to removably adhere the removable bonding layer to the other side of the perforated liner.

In one or more embodiments, the non-perforated removable bonding layer optionally comprises a plastic film or a paper or a synthetic paper that has a surface topography with a “surface depth” (the difference in the height of a peak and the depth of a trough, open pore or recess within one of said plurality of holes) of not less than 0.1 micron, preferably greater than 1 micron and more preferably greater than 5 micron. For a deformed or “micro-replicated” plastic film, the surface depth is preferably (but not necessarily) not less than 10 micron and more preferably not less than 20 micron. Such surface topography may be the result of any manufacturing process, for example the use of rollers with corresponding surface topography or a micro-replication process, for example to produce a plurality of pyramidal or conical protrusions, optionally truncated, a plurality of prismatic shapes, for example circular, square or triangular prisms projecting from a lower surface with substantially straight or sloping sides or mushroom or inverted zigurrat shaped protrusions or stalk or hair-shaped protrusions commonly referred to as setae. The surface topography can be regular or irregular, for example of exposed fibers in the parent material of the removable bonding layer or an additional coating, for example of fine particles of sand or other abrasive particles used in sandpaper or surface grinding processes. The surface area of the material can optionally be increased by means of an adhered fine net or fabric.

According to various embodiments, the removal of the additional marking material may be achieved either by the creation of discontinuities in the marking material, for example jetted ink, and/or sufficient area of surface contact between the additional marking material and the removable bonding layer and/or physical interlocking between the additional marking material and the removable bonding layer and/or chemical bond. However, other removal techniques may be used without deviating from the scope of the invention.

Optionally, the perforated liner has a black or other dark rear surface, so that when the removable bonding layer is removed with the unwanted ink, a black or other light absorbing surface is revealed to provide a one way-vision product.

These and/or other aspects of various embodiments of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

### BRIEF DESCRIPTION OF THE DRAWINGS

For a better understanding of embodiments of the present invention as well as other objects and further features thereof, reference is made to the following description which is to be used in conjunction with the accompanying drawings, where:

FIGS. 1A to 1G are diagrammatic cross-sections illustrating a production sequence of a one-way vision panel according to one or more embodiments of the invention.

FIG. 2 is an enlarged diagrammatic cross-section through an imaged perforated self-adhesive assembly with a removable bonding layer.

FIG. 3 is an enlarged diagrammatic cross-section through an imaged perforated self-adhesive assembly with a removable bonding layer.

FIG. 4 is an enlarged diagrammatic cross-section through an imaged perforated self-adhesive assembly with a removable bonding layer.

FIG. 5 is an enlarged diagrammatic cross-section through an imaged perforated self-adhesive assembly connected to a transparent panel.

FIGS. 6A to 6E are diagrammatic cross-sections illustrating a production sequence of a conventional one-way vision panel.

### DETAILED DESCRIPTION OF EXEMPLARY EMBODIMENTS OF THE INVENTION

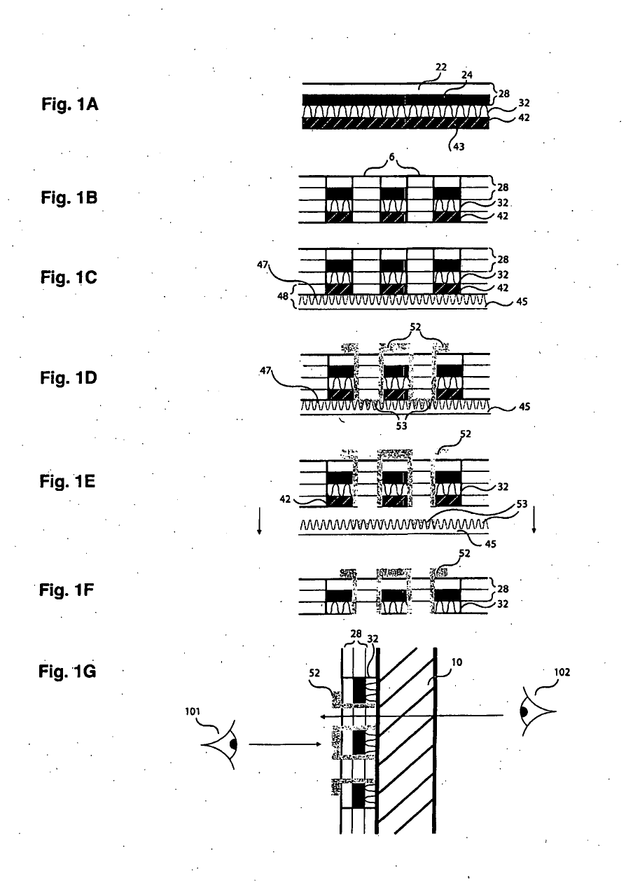

FIGS. 1A to 1G illustrate the manufacture of an assembly according to one or more embodiments of the invention. The assembly may be a one-way window graphic, for example as may be used for advertising, décor and/or security.

FIG. 1A illustrates a temporary assembly comprising face film 28 optionally comprising light-reflecting layer 22, typically white, and light absorbing layer 24, typically black, adhesive layer 32 and liner 42, optionally having light-absorbing external surface 43, typically black. It should be understood that face film 28 can be of any color, for example clear or white, of any filmic material, for example pvc, polyolefin, polyester or paper, and any single layer, laminated or coated construction. For example, light absorbing layer 24 could be a black coating. It should also be understood that adhesive layer 32 is optionally pressure-sensitive, for example a solvent, acrylic-based pressure-sensitive adhesive or a water-based pressure-sensitive adhesive. In FIG. 1B, all the layers of the temporary assembly are perforated with holes 6, typically circular holes within a range of hole diameter from 0.1 mm to 5 mm, preferably 1.0 to 2.0 mm diameter, typically arranged in a regular pattern, for example in a square grid or, preferably, in a staggered hole arrangement, more preferably in a 60° triangular layout. In FIG. 1C, a removable bonding layer 45 with bonding surface 47 is adhered to the perforated liner 42, optionally by means of heat-activated adhesive, to form composite liner 48.

FIG. 1D illustrates the assembly of FIG. 1C being imaged with design layer 52 by an imaging system in which unwanted marking material passes through the holes, including additional marking material 53. For example, inkjet printing with UV curable inks, commonly referred to as UV ink, typically resulting in ink continuity from the surface design layer 52 down the sides of the holes 6 to the ink deposited on the removable bonding layer 45, where it creates a strong bond to the bonding surface 47.

FIG. 1E shows the removal of removable bonding layer 45, taking with it additional marking material 53, leaving unobstructed holes 6. Following removal of perforated liner 42, in FIG. 1F, the imaged assembly can be adhered to one side of transparent panel 10, typically a window in a building or vehicle, by means of perforated adhesive layer 32, as showing in FIG. 1G, for example resulting in a one-way vision panel. Design layer 52 is visible to an observer 101 on the design facing side, typically outside the window 10, whereas observer 102 on the other side of the one-way vision panel has good through vision enabled by the holes 6 and light absorbing layer 24.

The bonding surface 47 optionally has a surface topography, diagrammatically shown as a surface with peaks and troughs, which enables a good bond to the additional marking material 53. Optionally, bonding surface 47 is of a bond enhancing surface coating, often referred to as a primer or primer coating, optionally on a plane surface of removable bonding layer 45 to suit the parent material of the removable bonding layer 45 and the imaging system, for example of UV ink.

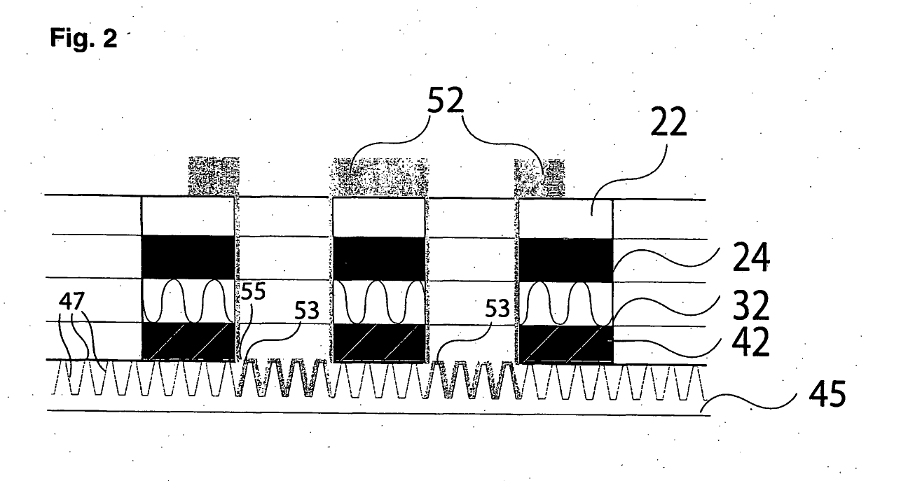

FIG. 2 is a larger scale diagrammatic cross-section corresponding to FIG. 1D but showing how the surface topography of removable bonding layer 45 can create marking material discontinuities 55 at the junctions of the hole edges and the removable bonding layer 45, one of the optional means of ensuring that additional marking material 53 does not bridge the holes.

According to one or more embodiments described in FIGS. 1A-1G and FIG. 2, the strength of the bond of additional marking material 53, for example an ink layer, within a perforation hole area, to the removable bonding layer 45 is preferably greater than the strength of the ink layer around the perimeter of the hole, such that on removal of the removable bonding layer from the perforated liner, for example at a specified rate, there is an ink fracture mechanism at the perimeter of the hole, such that ink deposited on the removable bonding layer 45 is removed with the removable bonding layer 45. The specified rate is determined for the particular ink and curing regime but is typically of the order of at least 2″ (50 mm) per second and preferably greater than 4″ (100 mm) per second.

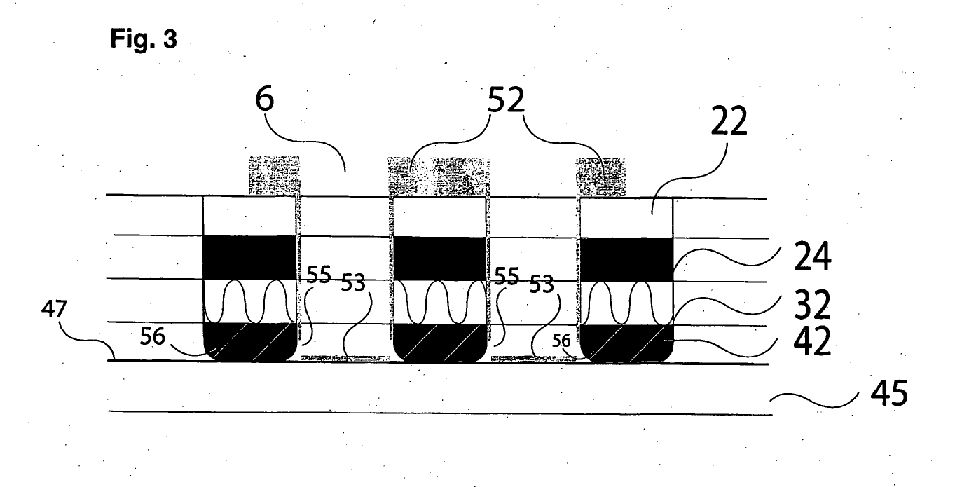

FIG. 3 illustrates a different type of removable bonding layer, in which the bonding surface 47 is spaced from the perforated liner 42 around the complete perimeter of a hole. This can be achieved, for example, by perforating the temporary assembly inverted or “upside down” to the conventional mode, an individual perforating tool first impacting upon the liner rather than the face film. The liner material suffers permanent deformation as the punching tool is forced through the assembly and into its corresponding die hole, typically seen as a circular depression around each hole, the typically curved edge 56 of the perimeter of each hole in the perforated liner 42 being spaced from the bonding surface 47 of the removable bonding layer 45. A paper or plastic film liner will deform in this manner because they are not elastic in their behavior, any restitution from the initially deformed state being only partial. Optionally, punching tools with a “shoulder” (for example comprising a frusto-conical shape) can be used to increase or control the deformation at the perimeter of each hole. While the bonding surface 47 is optionally plane or deformed or optionally comprises the surface of an adhesive enhancing surface coating or primer, this method provides a discontinuity between the hole 6 perimeter and the bonding surface 47, and the ink or other additional marking material 53 that passes through the holes 6 has a marking material discontinuity 55 with the ink or other marking material deposited on the sides of the holes. The bonding layer 42 material and the surface roughness or topography of bonding surface 47 depend on the means of enhancing bond or of creating marking material discontinuities 55. For the embodiment of FIG. 1C, the so-called “surface depth” of bonding surface 47 from the top of the highest point to the bottom of the deepest open pores or recesses is preferably not less than 0.1 micron and preferably greater than 1.0 micron and more preferably greater than 5.0 micron, for example of synthetic paper, whereas the surface topography of the embodiment of FIG. 3 is not as critical, requiring only nominal bond for the unwanted, additional marking material 53 to be removed with bonding layer 45. The bonding requirement of the bonding surface 47 may be reduced or minimal according to various embodiments, enabling the removable bonding layer 45 to comprise, for example, undeformed polypropylene film. Optionally a temporary protective film (not shown) is applied to the face film before such perforation of an inverted temporary assembly, to be subsequently removed before imaging. The temporary protective film protects the imaging surface during the perforation process. For example when transported over the die block of a conventional punch perforating machine contamination can occur from many causes, for example from cooling oil that unintentionally finds its way onto the die block, shards of one or more layers in a temporary assembly being perforated or dust that is commonly generated in a mechanical production environment. One suitable temporary protective film layer, for example, is polypropylene film.

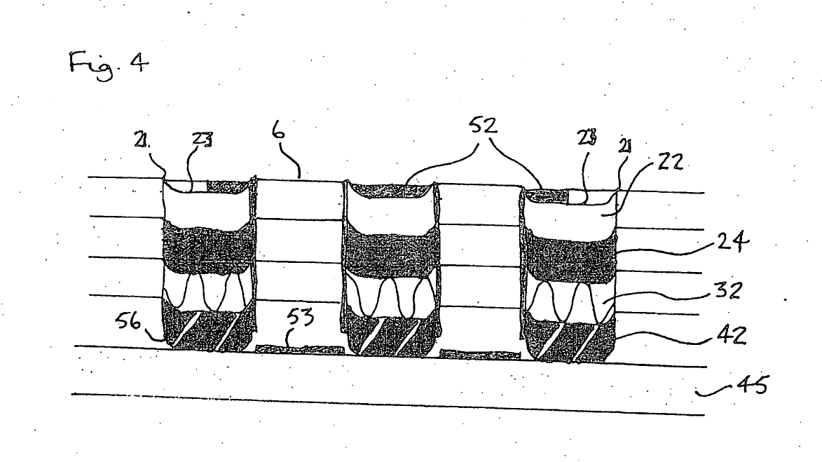

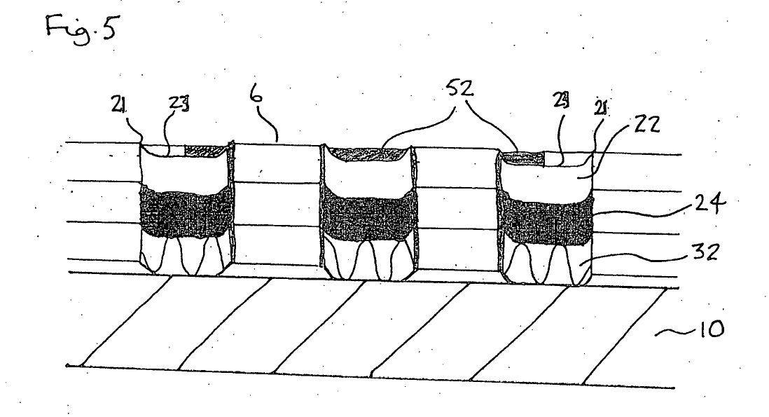

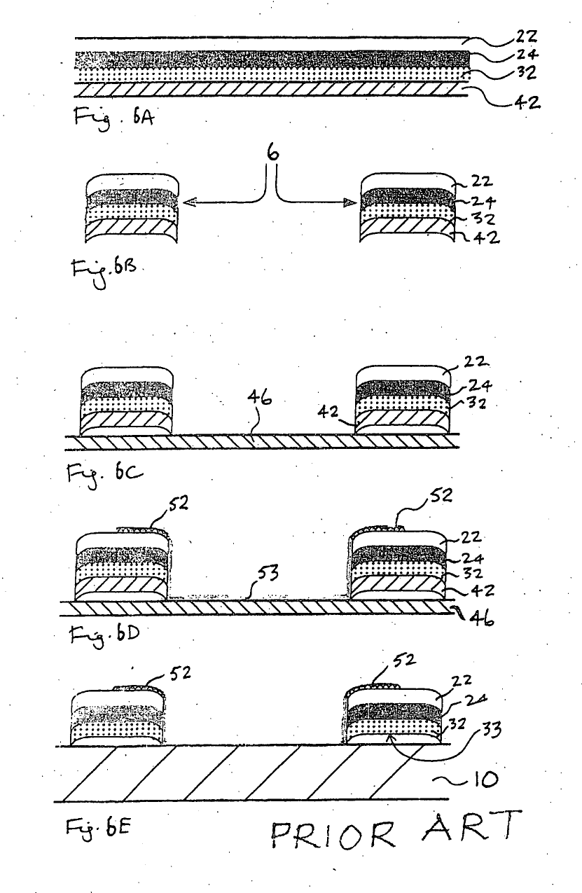

FIG. 3 is diagrammatic for ease of understanding, for example if the recessed curved edge 56 is created by means of inverted perforation, then one or more of the other layers in the assembly will also typically be distorted, as represented diagrammatically in FIG. 4 in which adhesive layer 32 and film layers 22 and 24 are also distorted, providing a concave imaging surface 23 to facefilm 28. This effect is typically more pronounced with harder, less flexible face films, for example some types of polyolefin and polyester. With some imaging systems, projections or protrusions 21 around the perimeter of each hole in the imaging surface 23 provide a protection to abrasion to the marking material comprising surface design layer 52. Providing the surface protrusion(s) 21 of the hole perimeter is sufficiently small to prevent damage to inkjet printheads according to various embodiments, for example within a surface depth or difference between the high point of a hole perimeter and the low point of an adjacent continuous imaging surface 23 around the hole of less than 0.5 mm, this should not lead to damage to printheads in most types of commercial large format inkjet printing equipment. However, a “surface depth” of at least 5 micron and preferably greater than 10 micron will provide significant protection to abrasion to inkjet ink deposited on the imaging surface 23. However, various embodiments may have a surface depth of less than 5 microns or more than 10 microns without deviating from the scope of the invention. According to various embodiments, the surface depth is at least 1, 2, 3, 4, 5, 6, 7, 8, 9, and/or 10 microns, and/or less than 100, 50, and/or 20 microns, and or within any range between any two such depths. There is yet another feature of inverted perforation of such a self-adhesive assembly according to various embodiments, in that upon removal of the perforated liner 42, the surface of the adhesive will be convex or substantially flat with perimeter edge distortion 56, presenting a substantially plane (flat) surface of adhesive to a base panel 10, for example a glass window, as shown in FIG. 5. This contrasts with the prior art of perforation of a self-adhesive assembly and the addition of an “additional non-perforated backing layer” sometimes referred to as an “additional liner”, as illustrated in FIGS. 6A-6E. The additional liner 46 “locks in” the distortion, including the concave surface of the perforated adhesive layer 32 which, upon removal of the perforated liner 42, presents a substantially concave adhesive surface 33 to the base panel or window 10 upon initial application, direct contact being limited to the adhesive around the perimeter of each hole, as illustrated in FIG. 6E. This undesirable effect worsens along the length of a perforation run as perforation punching tools became increasingly blunt, resulting in relatively weak and inconsistent adhesion characteristics of the resultant perforated self-adhesive assembly. In contrast, one or more non-limiting embodiments of the present invention comprising inverted perforation provide a relatively consistent contact surface and consequent adhesive performance, compared to the prior art “additional liner” constructions. Optionally, one or more non-limiting embodiments of the present invention provides one, some, and/or all of the following features:
(i) reliable removal of additional marking material 53 that passes through the holes, leaving no residual ink spanning across any individual hole. Alternatively, if for any reason this process is not entirely effective and one or more holes remain blocked with additional marking material 53, these can easily be cleared, for example by an individual pin or punch tool, by a printer before shipment of the printed product,
(ii) upon removal of the removable bonding layer 45, a light-absorbing surface to the exposed perforated liner 42 provides a one-way vision assembly, which can also be assessed in the printer's works for suitability before shipment to site, removal of the perforated liner and application to a window,
(iii) an inverted perforated assembly results in a continuous gap 55 around the perimeter of each hole which facilitates and/or ensures that additional marking material 53 is removed with the removable bonding layer 45, and
(iv) an inverted perforated assembly results in surface distortion of the facefilm 22, typically in the form of an even or uneven projection around the perimeter of each hole, which in turns provides a protection against abrasion to imaging material in design layer 52.

The foregoing illustrated embodiments are provided to illustrate the structural and functional principles of embodiments of the present invention and are not intended to be limiting. On the contrary, the principles of the present invention are intended to encompass any and all changes, alterations and/or substitutions within the spirit and scope of the following claims.

What is claimed is:

1. A perforated self-adhesive film assembly capable of being imaged, the assembly comprising:
a perforated face film;
a perforated adhesive layer;
a perforated liner, each of the perforated face film, perforated adhesive layer, and perforated liner being perforated with a plurality of holes; and
a removable non-perforated bonding layer removably attached to the perforated liner, the removable bonding layer comprising a bonding surface, the bonding surface comprising one or more of the following:
i) a surface topography surface depth with a difference between the height of a peak and the depth of a trough within one of said plurality of holes of not less than 0.1 micron,
ii) an adhesion enhancing surface coating, or
(iii) a surface spaced from said perforated liner around the complete perimeter of one of said plurality of holes.

2. An assembly as claimed in claim 1, wherein the removable non-perforated bonding layer has a surface depth of not less than 1.0 micron.

3. An assembly as claimed in claim. 1, wherein the removable non-perforated bonding layer has a surface depth of not less than 5.0 micron.

4. A method of making a perforated self-adhesive assembly capable of being imaged, the assembly comprising a perforated face film, a perforated adhesive layer and a perforated liner, each of the perforated face film, perforated adhesive layer, and perforated liner being perforated with a plurality of holes, and a removable non-perforated bonding layer removably attached to the perforated liner, the removable bonding layer comprising a bonding surface, the bonding surface comprising one or more of the following:
(i) a surface topography with a difference between the height of a peak and the depth of a trough within one of said plurality of holes of not less than 5 micron,
(ii) an adhesion enhancing surface coating, or
(iii) a surface spaced from said perforated liner around the complete perimeter of one of said plurality of holes,
said method comprising:
a) forming a temporary assembly comprising a face film, an adhesive layer and a liner;
b) perforating said temporary assembly with a plurality of holes to form a perforated sub-assembly comprising the perforated face film, perforated adhesive layer, and perforated liner; and
c) removably adhering said non-perforated bonding layer to the perforated liner side of the perforated sub-assembly.

5. A method as claimed in claim 4, further comprising, after c):
imaging said perforated face film with a design layer comprising marking material to form an imaged perforated face film such that additional marking material that passes through said one of said plurality of holes is adhered to said non-perforated removable bonding layer; and
e) removing said non-perforated bonding layer with said additional marking material.

6. A method as claimed in claim 5, further comprising, after e):
f) removing said perforated liner from said perforated adhesive layer; and
g) adhering said imaged perforated face film and said perforated adhesive layer to a non-perforated transparent material.

7. A method as claimed in claim 4, wherein said perforating comprises perforating said temporary assembly using punch tools that impact the liner first.

8. A method as claimed in claim 5, wherein said perforating comprises perforating said temporary assembly using punch tools that impact the liner first.

9. A method as claimed in claim 6, wherein said perforating comprises perforating said temporary assembly using punch tools that impact the liner first.
